(19) United States
(12) Patent Application Publication
(10) Pub. No.: US 2019/0018479 A1
(43) Pub. Date: Jan. 17, 2019

(54) PROGRAM FOR PROVIDING VIRTUAL SPACE, INFORMATION PROCESSING APPARATUS FOR EXECUTING THE PROGRAM, AND METHOD FOR PROVIDING VIRTUAL SPACE

(71) Applicant: COLOPL, Inc., Tokyo (JP)

(72) Inventor: Tomohiro MINAMI, Tokyo (JP)

(21) Appl. No.: 15/989,675

(22) Filed: May 25, 2018

(30) Foreign Application Priority Data
May 26, 2017 (JP) 2017-104815

(51) Int. Cl. G06F 3/01

(52) U.S. Cl. CPC G06F 3/013; G06F 3/0482; G06F 3/011

(57) ABSTRACT

A method of providing a virtual space includes defining a virtual space, wherein the virtual space comprises an operation object and a target object. The method further includes detecting a line of sight of a user wearing a head-mounted device (HMD). The method further includes identifying whether the detected line of sight intersects with the target object. The method further includes detecting a motion of a part of a body of the user. The method further includes moving the operation object in accordance with the detected motion. The method further includes performing an operation on the identified target object in accordance with the detected motion in response to the detected line of sight intersecting with the target object.

### RELATED APPLICATIONS

The present application claims priority to Japanese Application No. 2017-104815, filed on May 26, 2017, the disclosure of which is hereby incorporated by reference herein in its entirety.

### TECHNICAL FIELD

This disclosure relates to a technology for providing a virtual space, and more particularly, to a technology for assisting a user operation in the virtual space.

### BACKGROUND

A technology for providing a virtual space (also called “virtual reality space”) by using a head-mounted device (HMD) is known. There have been proposed various technologies for enriching an experience of a user in the virtual space.

For example, in Non Patent Document 1, there is described a technology in which, in a shooting game in a virtual space, a target object is aimed at by using a line of sight of a user.

In Non Patent Document 2, there is described a technology in which only a portion of a line of sight of a user in a virtual space is rendered at a high resolution, and other portions in the virtual space are rendered at a low resolution.

### NON PATENT DOCUMENTS

### Non Patent Document 1

“Large Change in Experience with Single Line of Sight. VR Headset equipped with Eye Tracking System ‘FOVE ’ ”, [online], [retrieved on May 10, 2017], Internet <URL: http://www.gizmodo.jp/2016/09/tgs2016-vr-fove.html>

### Non Patent Document 2

“Latest Trends in ‘Foveated Rendering’ For Realizing High-End VR at Ultra-Low Load”, [online], [retrieved on May 11, 2017], Internet <URL: http://game.watch.impress.co.jp/docs/series/vrgaming/745831.ht ml>

### SUMMARY

According to at least one embodiment, there is provided a method of providing a virtual space. The method includes defining a virtual space, the virtual space including an operation object and a target object. The method further includes detecting a line of sight of a user wearing a head-mounted device (HMD). The method further includes identifying that the target object has been selected by the line of sight. The method further includes detecting a motion of a part of a body of the user. The method further includes moving the operation object in accordance with the detected motion. The method further includes receiving an operation on the identified target object in accordance with the detected motion.

The above-mentioned and other objects, features, aspects, and advantages of the disclosure may be made clear from the following detailed description of this disclosure, which is to be understood in association with the attached drawings.

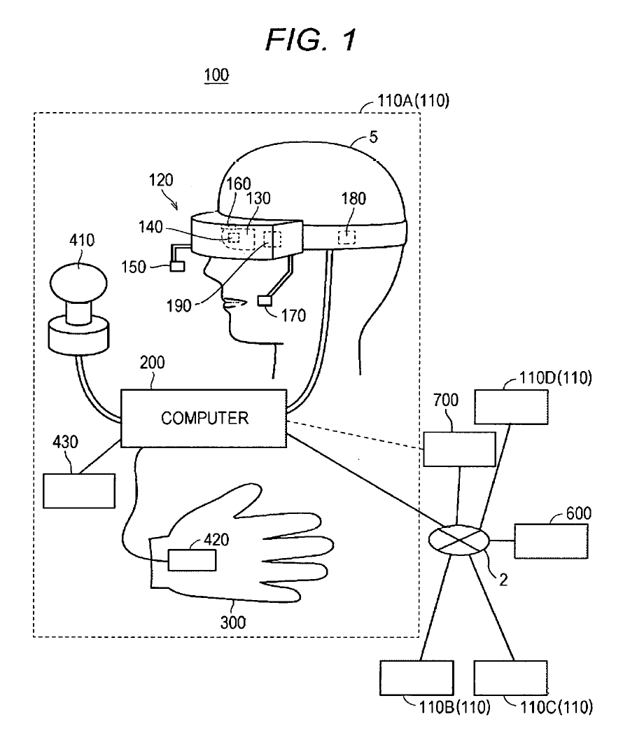

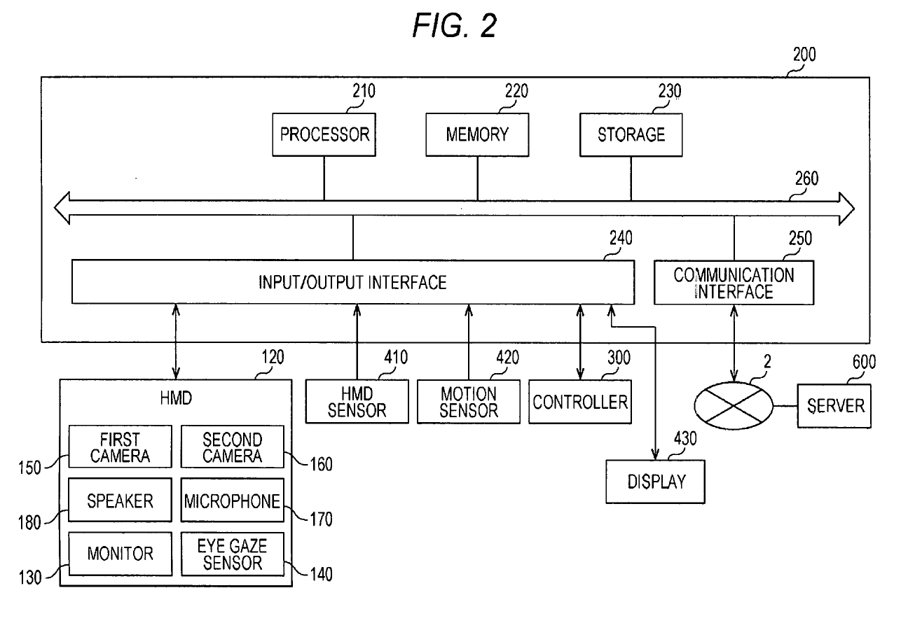

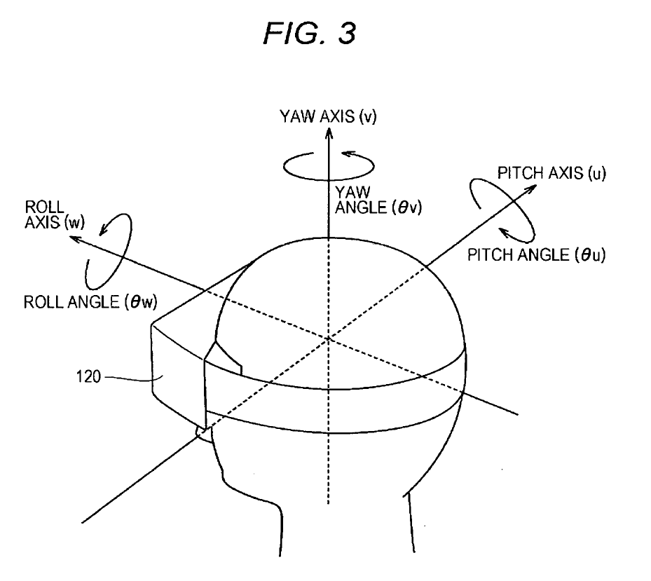

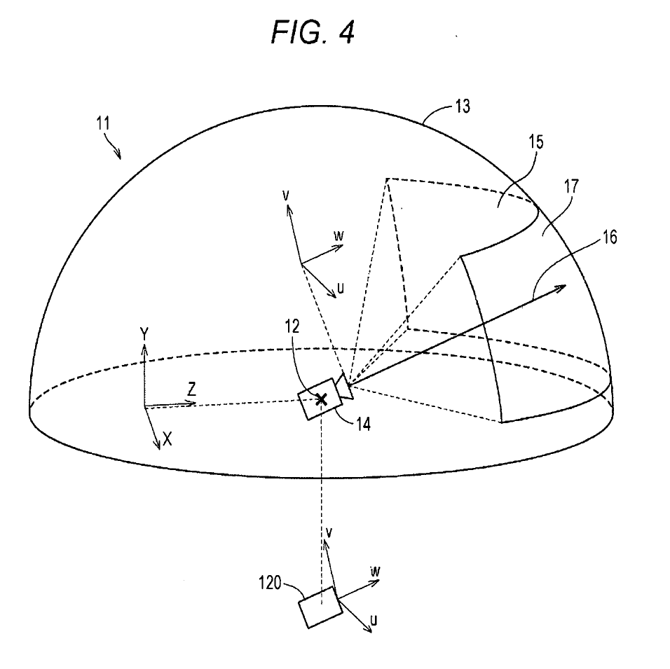

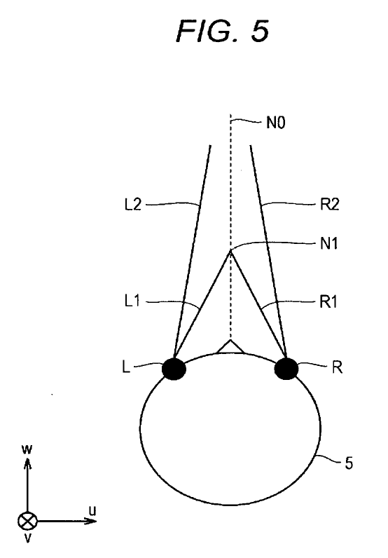

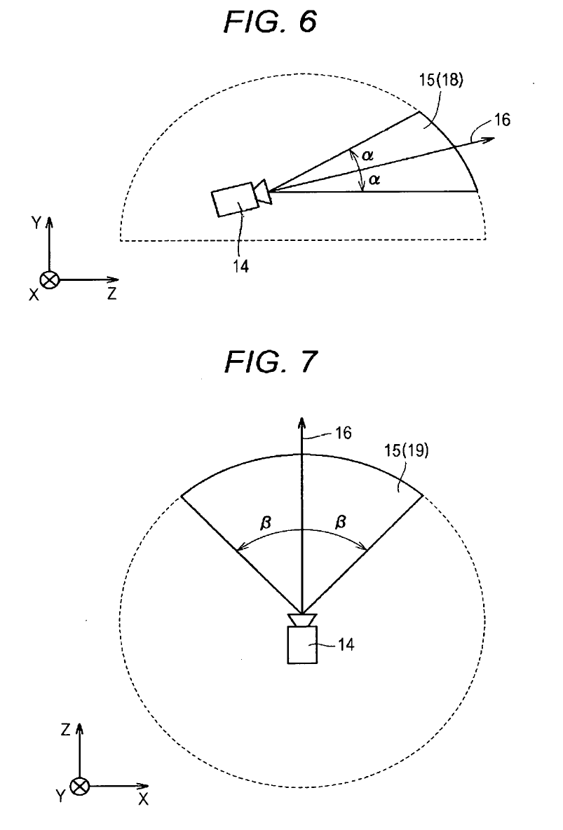

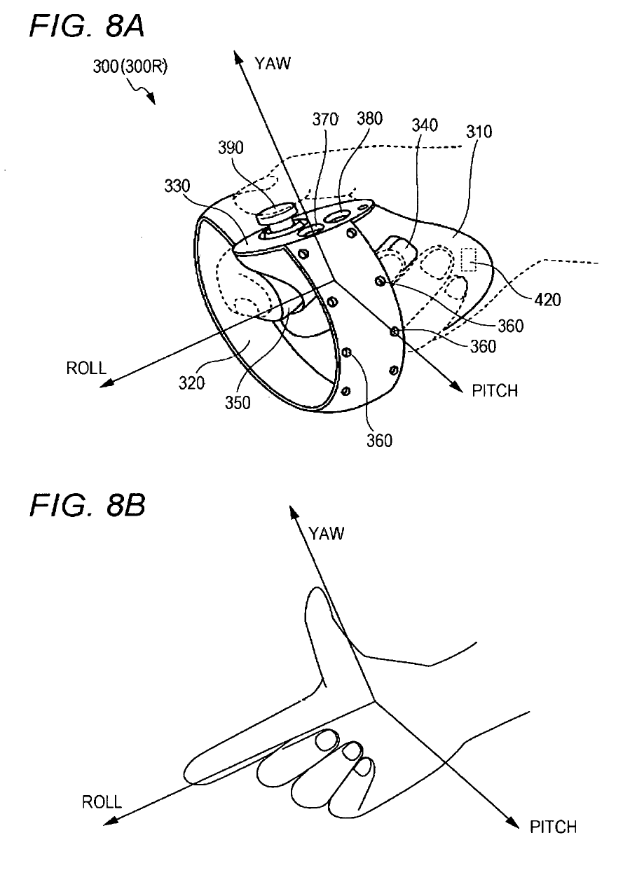

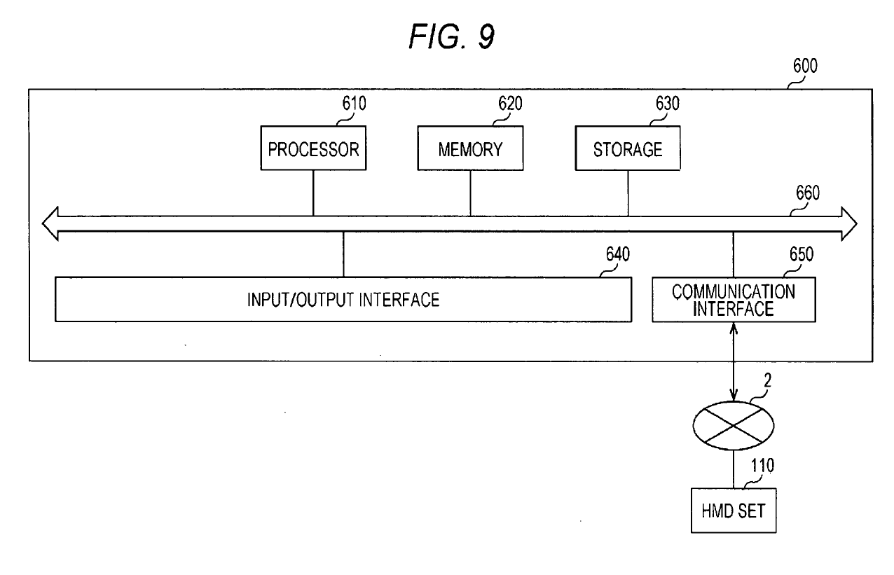

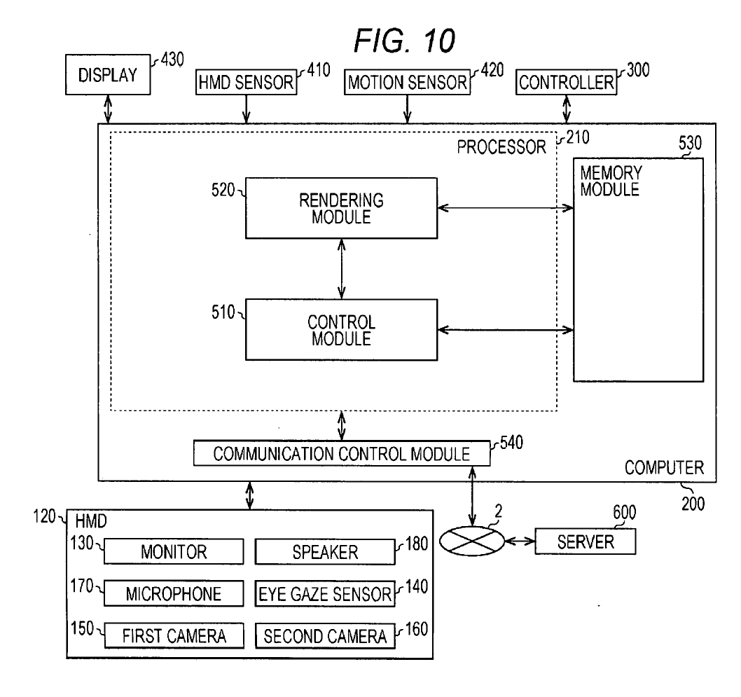

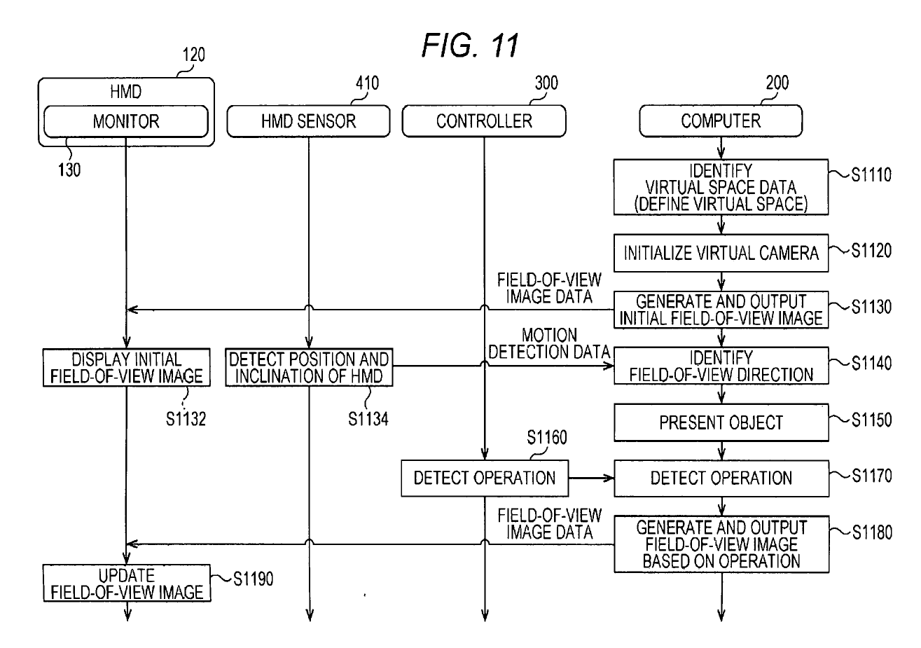

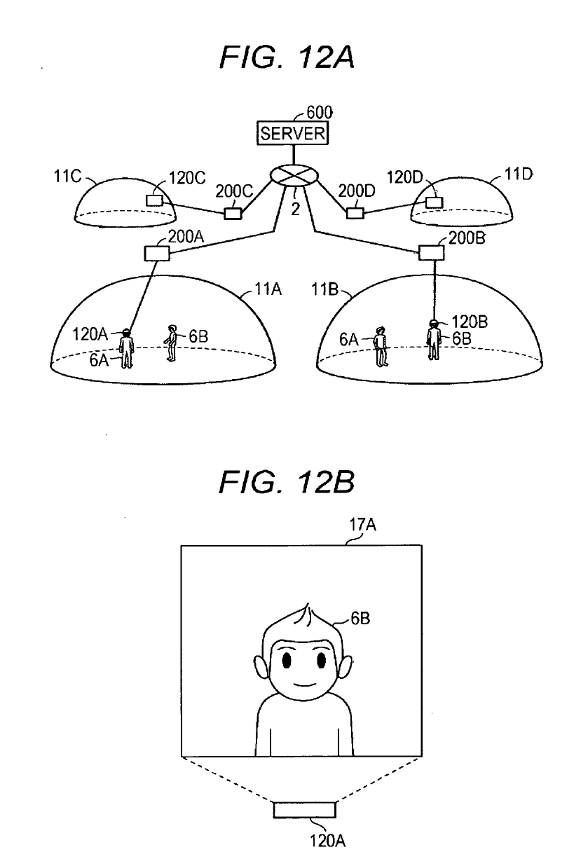

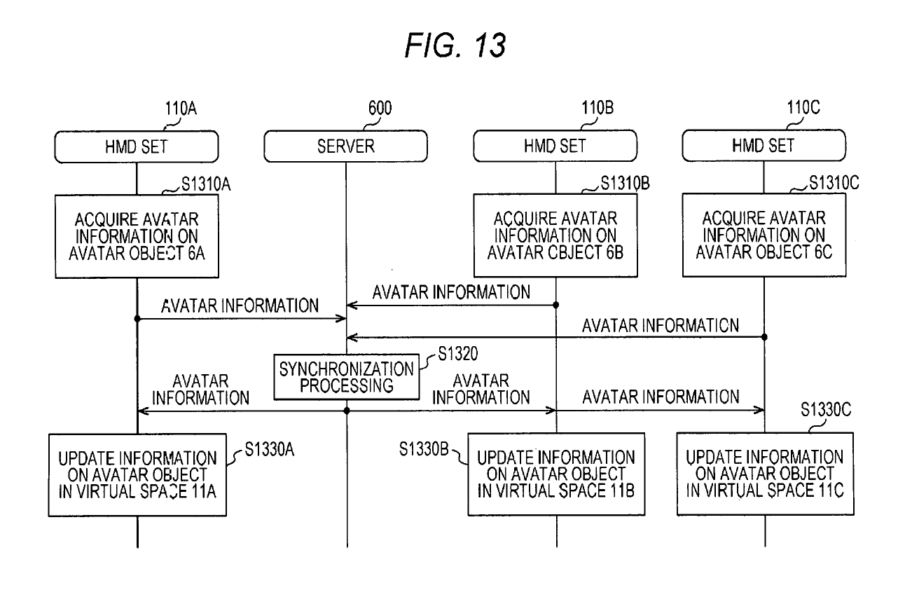

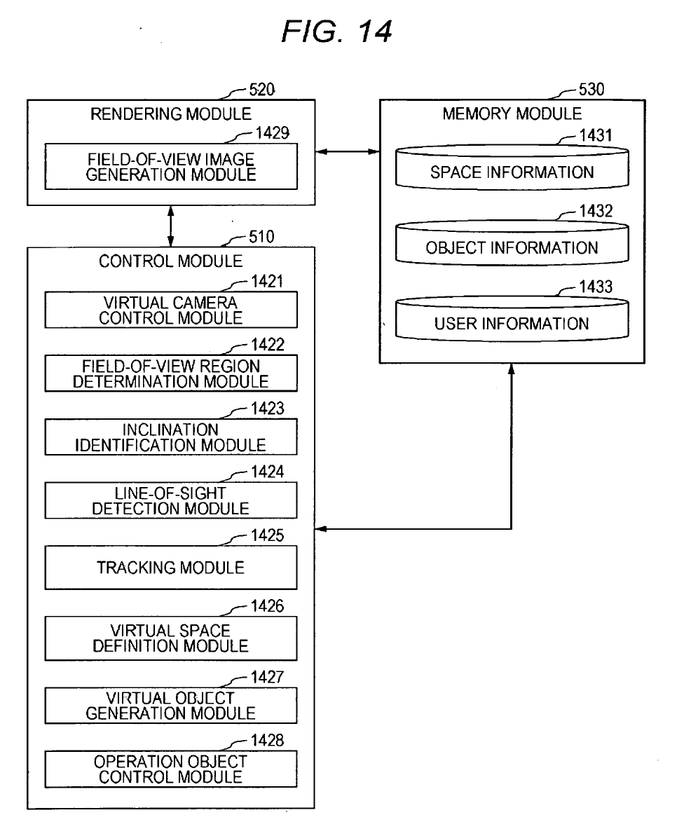

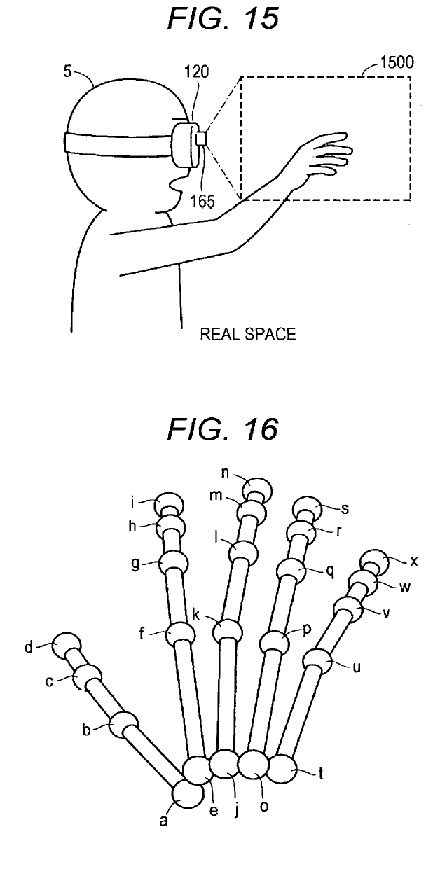

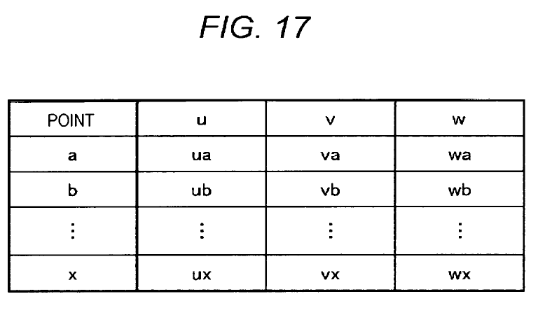

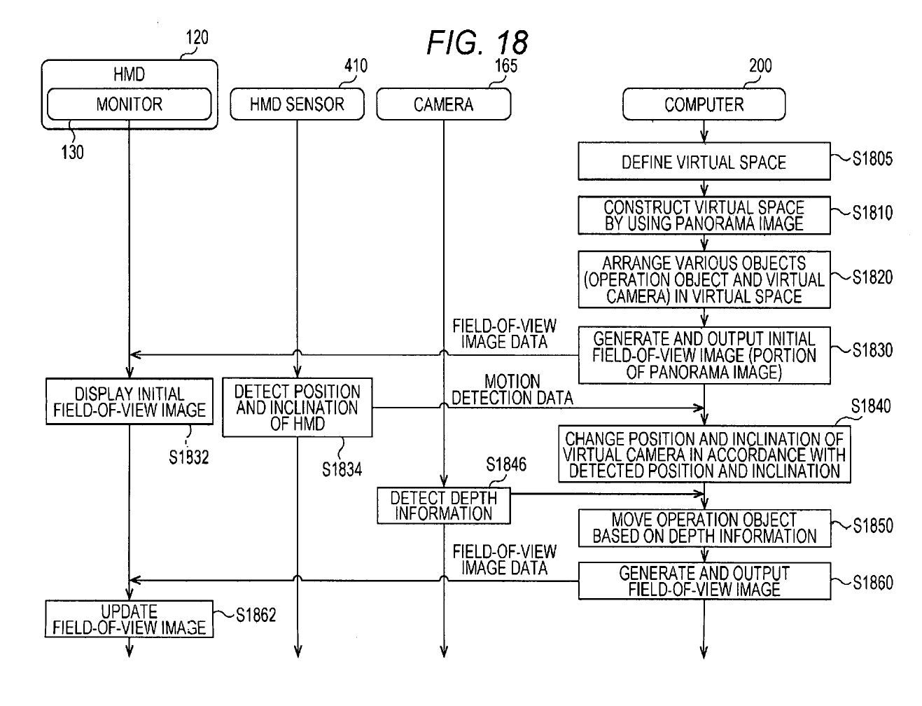

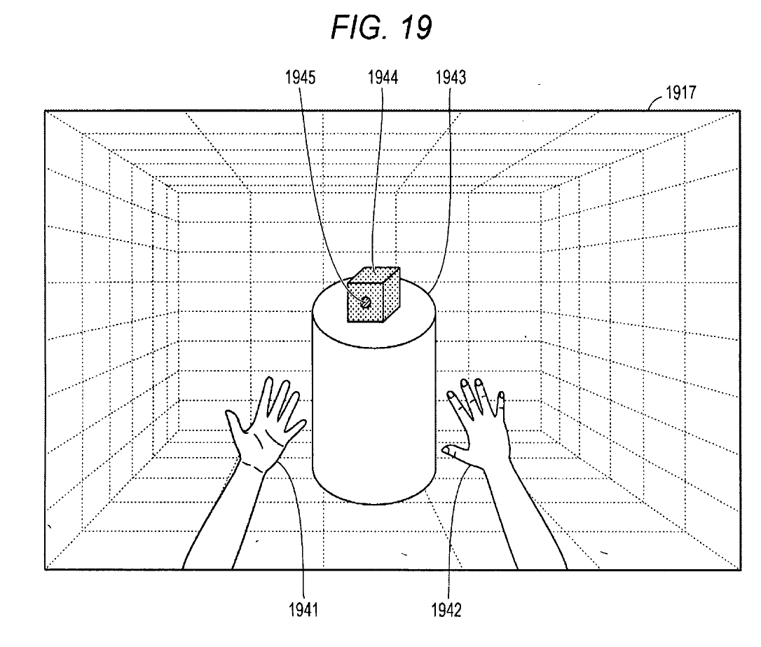

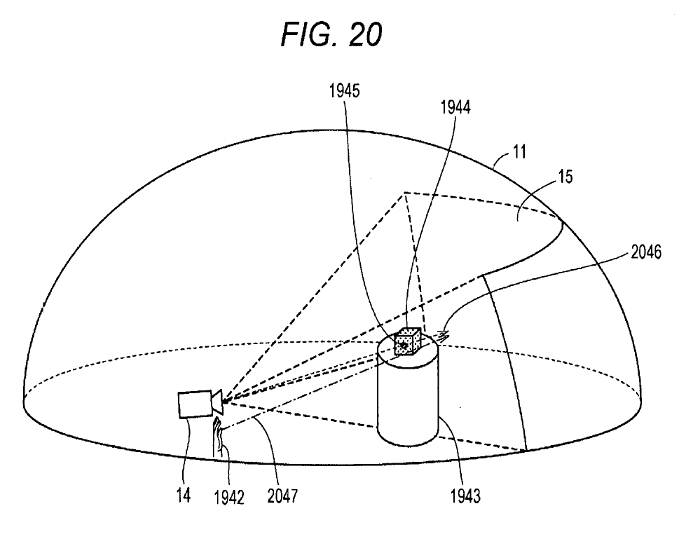

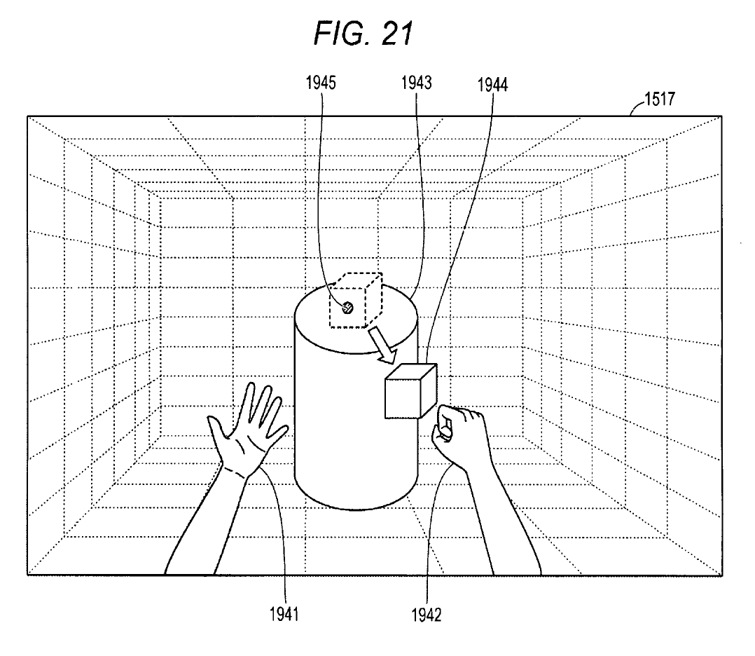

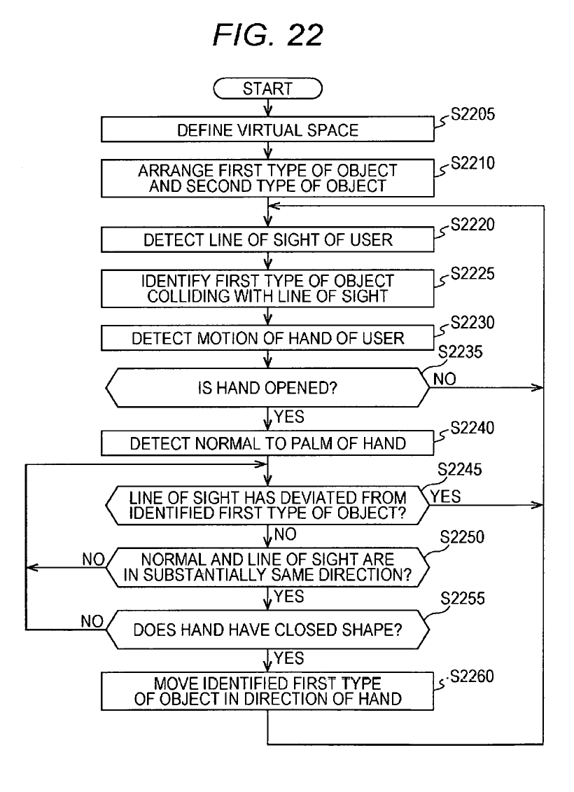

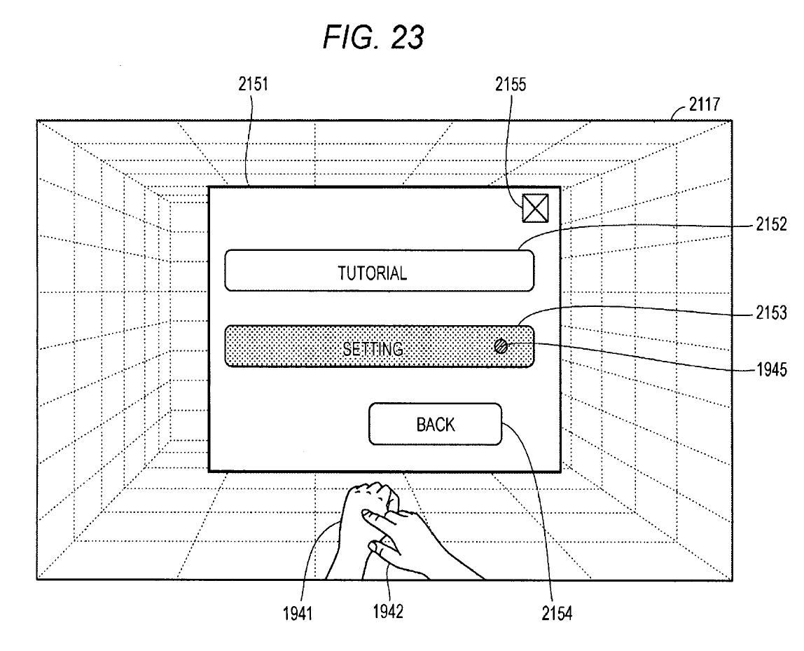

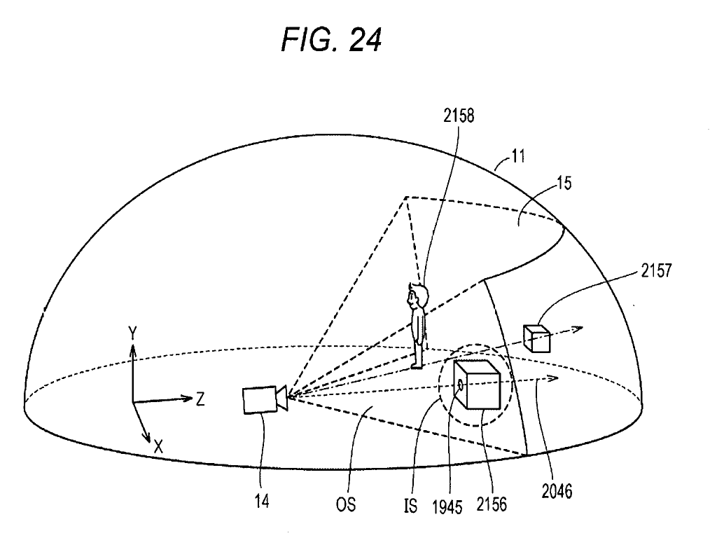

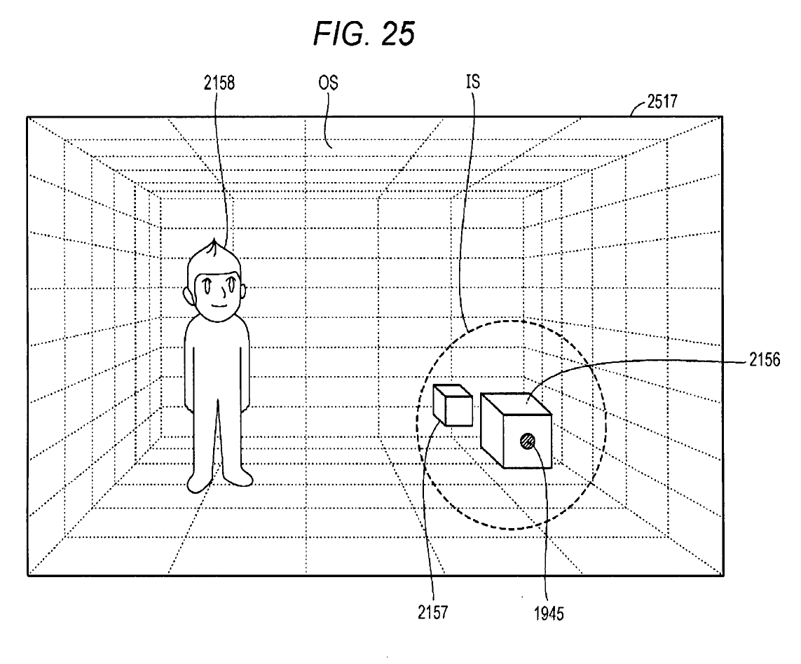

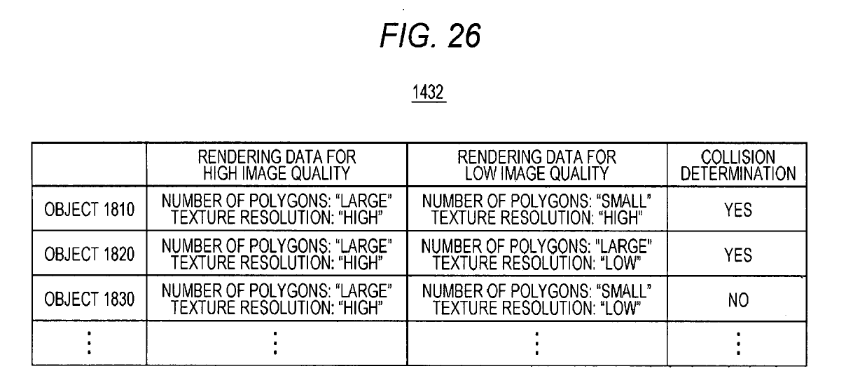

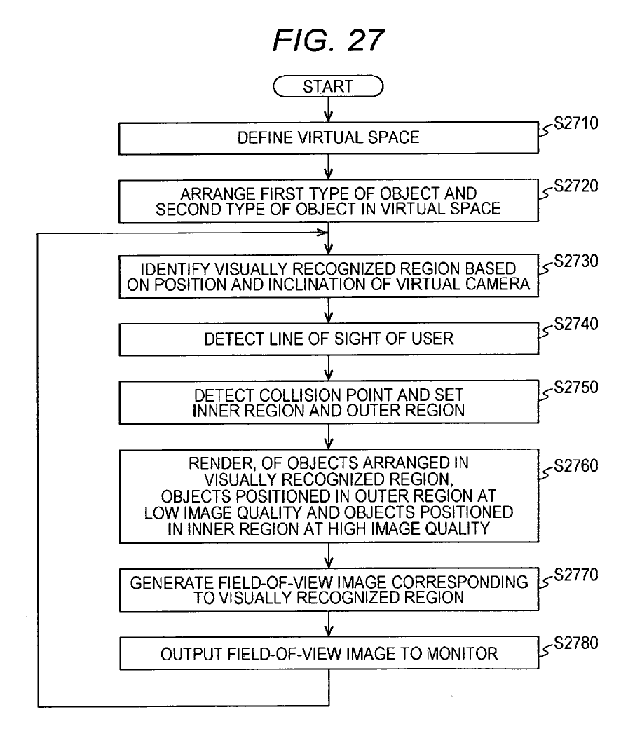

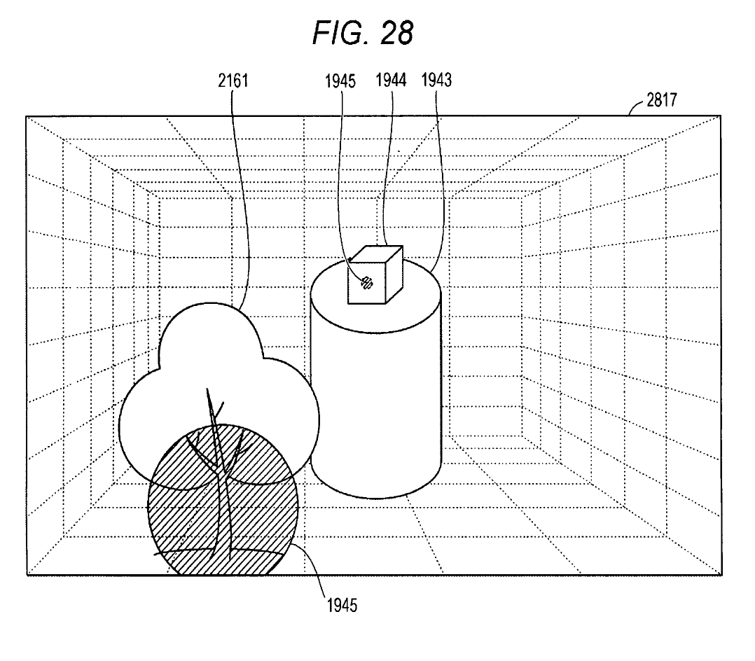

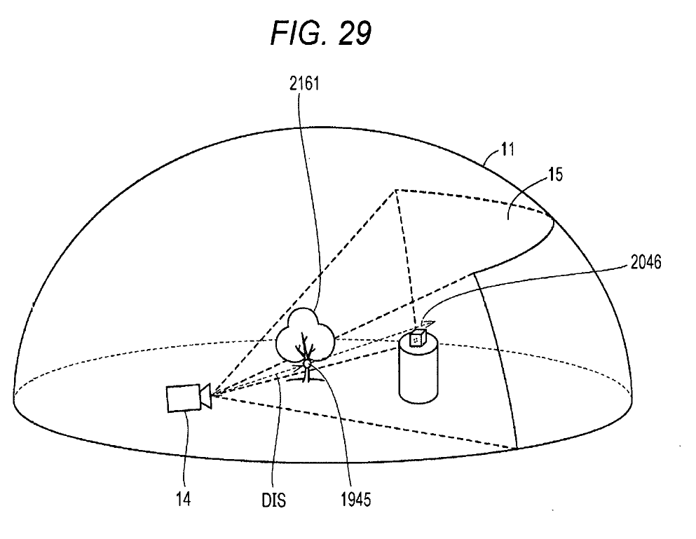

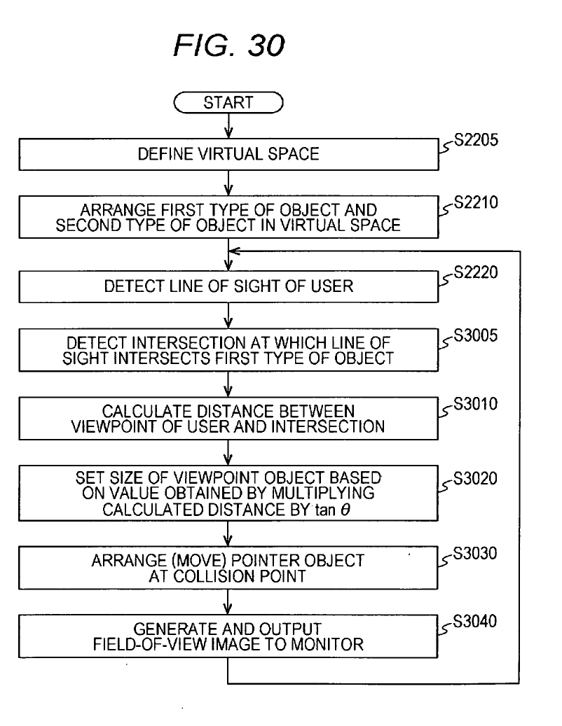

### BRIEF DESCRIPTION OF THE DRAWINGS

[FIG. 1] A diagram of a system including a head-mounted device (HMD) according to at least one embodiment of this disclosure.

[FIG. 2] A block diagram of a hardware configuration of a computer according to at least one embodiment of this disclosure.

[FIG. 3] A diagram of a uvw visual-field coordinate system to be set for an HMD according to at least one embodiment of this disclosure.

[FIG. 4] A diagram of a mode of expressing a virtual space according to at least one embodiment of this disclosure.

[FIG. 5] A diagram of a plan view of a head of a user wearing the HMD according to at least one embodiment of this disclosure.

[FIG. 6] A diagram of a YZ cross section obtained by viewing a field-of-view region from an X direction in the virtual space according to at least one embodiment of this disclosure.

[FIG. 7] A diagram of an XZ cross section obtained by viewing the field-of-view region from a Y direction in the virtual space according to at least one embodiment of this disclosure.

[FIG. 8A] A diagram of a schematic configuration of a controller according to at least one embodiment of this disclosure.

[FIG. 8B] A diagram of a coordinate system to be set for a hand of a user holding the controller according to at least one embodiment of this disclosure.

[FIG. 9] A block diagram of a hardware configuration of a server according to at least one embodiment of this disclosure.

[FIG. 10] A block diagram of a computer according to at least one embodiment of this disclosure.

[FIG. 11] A sequence chart of processing to be executed by a system including an HMD set according to at least one embodiment of this disclosure.

[FIG. 12A] A schematic diagram of HMD systems of several users sharing the virtual space interact using a network according to at least one embodiment of this disclosure.

[FIG. 12B] A diagram of a field of view image of a HMD according to at least one embodiment of this disclosure.

[FIG. 13] A sequence diagram of processing to be executed by a system including an HMD interacting in a network according to at least one embodiment of this disclosure.

[FIG. 14] A block diagram of modules of the computer according to at least one embodiment of this disclosure.

[FIG. 15] A diagram of processing of tracking a hand according to at least one embodiment of this disclosure.

[FIG. 16] A diagram of operation of a tracking module according to at least one embodiment of this disclosure.

[FIG. 17] A diagram of a data structure of tracking data according to at least one embodiment of this disclosure.

[FIG. 18] A flowchart of processing to be executed according to at least one embodiment of this disclosure.

[FIG. 19] A diagram of a field-of-view image of the user according to at least one embodiment of this disclosure.

[FIG. 20] A diagram of a virtual space corresponding to the field-of-view image in FIG. 19 according to at least one embodiment of this disclosure.

[FIG. 21] A diagram of a field-of-view image after a right hand object has transitioned from an opened state to a closed state according to at least one embodiment of this disclosure.

[FIG. 22] A flowchart of processing of receiving a user operation based on a line of sight of the user and a motion of a part of his or her limbs according to at least one embodiment of this disclosure.

[FIG. 23] A diagram of tactile feedback processing according to at least one embodiment of this disclosure.

[FIG. 24] A diagram of an inner region and an outer region according to at least one embodiment of this disclosure.

[FIG. 25] A diagram of a field-of-view image corresponding to a visually recognized region of FIG. 24 according to at least one embodiment of this disclosure.

[FIG. 26] A diagram of a data structure of object information according to at least one embodiment of this disclosure.

[FIG. 27] A flowchart of a series of controls for reducing an image processing load on the computer according to at least one embodiment of this disclosure.

[FIG. 28] A diagram of a field-of-view image including a pointer object according to at least one embodiment of this disclosure.

[FIG. 29] A diagram of the virtual space corresponding to the field-of-view image in FIG. 28 according to at least one embodiment of this disclosure.

[FIG. 30] A flowchart of processing for controlling a size of the pointer object in the virtual space according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIGS. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Configuration of Modules]

With reference to FIG. 14, a module configuration of the computer 200 are described. FIG. 14 is a block diagram of a configuration of modules of the computer 200 according to at least one embodiment of this disclosure.

In FIG. 14, the control module 510 includes a virtual camera control module 1421, a field-of-view region determination module 1422, an inclination identification module 1423, a line-of-sight detection module 1424, a tracking module 1425, a virtual space definition module 1426, a virtual object generation module 1427, and an operation object control module 1428. The rendering module 520 includes a field-of-view image generation module 1429. The memory module 530 stores space information 1431, object information 1432, and user information 1433.

In at least one aspect, the control module 510 controls an image displayed on the monitor 130 of the HMD 120.

The virtual camera control module 1421 arranges the virtual camera 14 in the virtual space 11. Further, the virtual camera control module 1421 controls a position of the virtual camera 14 in the virtual space 11 and the inclination (reference line of sight 16) of the virtual camera 14. More specifically, the virtual camera control module 1421 controls the inclination of the virtual camera 14 in association with the inclination of the HMD 120 identified by the inclination identification module 1423, which is described later.

The field-of-view region determination module 1422 defines the field-of-view region 15 in accordance with the position and inclination of the virtual camera 14. The field-of-view image generation module 1429 generates the field-of-view image 17 to be displayed on the monitor 130 based on the determined field-of-view region 15.

The inclination identification module 1423 identifies the inclination of the HMD 120 (direction in which the head of the user 5 is facing) based on the output of the sensor 114 or the HMD sensor 410.

The line-of-sight detection module 1424 detects the line of sight of the user 5 based on the signal from the gaze sensor 140.

The tracking module 1425 detects (tracks) the position of a part of the body of the user 5 for each photography cycle of a third camera 165, which is described later. In at least one embodiment, the tracking module 1425 detects the position of the hand of the user 5 in the uvw visual-field coordinate system set in the HMD 120 based on depth information input from the third camera 165. The motion of the tracking module 1425 is described later.

The control module 510 controls the virtual space 11 provided to the user 5. The virtual space definition module 1426 defines the virtual space 11 in the HMD system 100 by generating virtual space data representing the virtual space 11.

The virtual object generation module 1427 generates objects to be arranged in the virtual space 11. The objects may include, for example, forests, mountains, other landscapes, and animals to be arranged in accordance with the progression of the story of the game.

The operation object control module 1428 arranges, in the virtual space 11, an operation object for receiving an operation of the user 5 in the virtual space 11. The user 5 operates the operation object to operate an object arranged in the virtual space 11, for example. In at least one aspect, the operation object is a hand object corresponding to a hand of the user 5 wearing the HMD 120. In this case, the operation object control module 1428 translates the motion of the hand of the user 5 in the real space to the operation object (hand object) based on output of the tracking module 1425. In at least one aspect, the hand object corresponds to a hand part of the avatar object corresponding to the user 5.

When one object arranged in the virtual space 11 collides with another object, the control module 510 detects the collision. The control module 510 is able to detect, for example, a timing at which one object and another object have touched with each other, and performs predetermined processing in response to the detected timing. The control module 510 is able to detect a timing at which an object and another object, which have been in contact with each other, have moved away from each other, and performs predetermined processing in response to the detected timing. The control module 510 is able to detect a state in which an object and another object are in contact with each other. For example, when an operation object touches another object, the operation object control module 1428 detects the fact that the operation object has touched the other object, and performs predetermined processing.

The space information 1431 stores one or more templates that are defined to provide the virtual space 11. The space information 1431 may further store the plurality of panorama images 13 to be developed in the virtual space 11. The panorama images 13 may contain an image of a non-real space and an image of the real space.

The object information 1432 stores modeling data for rendering the objects arranged in the virtual space 11.

The user information 1433 stores a program and the like for causing the computer 200 to function as a control apparatus for the system 100. The user information 1433 may also store, for example, a user ID (e.g., an internet protocol (IP) address or the like set to the computer 200) for identifying the user 5.

[Hand Tracking]

Next, with reference to FIG. 15 to FIG. 17, a description is given of processing of tracking motion of the hand. FIG. 15 is a diagram of processing of tracking the hand.

Referring to FIG. 15, the user 5 is wearing the HMD 120 in the real space. The third camera 165 is mounted on the HMD 120. The third camera 165 acquires depth information on objects contained in a space 1500 ahead of the HMD 120. In the example illustrated in FIG. 15, the third camera 165 acquires depth information on a hand of the user 5 contained in the space 1500.

The third camera 165 is capable of acquiring depth information on a target object. As at least one example, the third camera 165 acquires depth information on a target object in accordance with a time-of-flight (TOF) method. As at least one example, the third camera 165 acquires depth information on a target object in accordance with a pattern irradiation method. In at least one embodiment, the third camera 165 may be a stereo camera capable of photographing a target object from two or more different directions. The third camera 165 may be a camera capable of photographing infrared rays that are invisible to people. The third camera 165 is mounted on the HMD 120 and photographs a part of the body of the user 5. In the following description, as an example, the third camera 165 photographs a hand of the user 5. The third camera 165 outputs the acquired hand depth information on the hand of the user 5 to the computer 200.

The tracking module 1425 generates position information on the hand (hereinafter also referred to as “tracking data”) based on the depth information. The third camera 165 is mounted on the HMD 120. Therefore, the tracking data indicates coordinate values in the uvw visual-field coordinate system set in the HMD 120.

FIG. 16 is a diagram of operation of the tracking module 1425 according to at least one embodiment of this disclosure. In at least one aspect, the tracking module 1425 tracks the motion of the bones of the hand of the user 5 based on the depth information input from the third camera 165. In FIG. 16, the tracking module 1425 detects the position of each of joints a, b, c, . . . , x of the hand of the user 5.

The tracking module 1425 is capable of recognizing a shape (finger motion) of the hand of the user 5 based on the positional relationship among the joints a to x. The tracking module 1425 is able to recognize, for example, that the hand of the user 5 is pointing with a finger, that the hand is open, that the hand is closed, that the hand is performing a motion of grasping something, that the hand is twisted, that the hand is taking a shaking-hand shape, and the like. The tracking module 1425 is also able to determine whether the recognized hand is a left hand or a right hand based on the positional relationship between the joints a to d and other joints. Such a third camera 165 and tracking module 1425 may be implemented by, for example, Leap Motion (trademark) provided by Leap Motion, Inc.

FIG. 17 is a diagram of the data structure of the tracking data. The tracking module 1425 acquires coordinate values (tracking data) in the uvw visual-field coordinate system for each of the joints a to x.

[Control Structure of Computer 200]

A control structure of the computer 200 according to at least one embodiment of this disclosure is now described with reference to FIG. 18. FIG. 18 is a flowchart of processing executed by the HMD system 100 according to at least one embodiment of this disclosure.

In Step S1805, the processor 210 of the computer 200 serves as the virtual space definition module 1426 to define the virtual space 11.

In Step S1810, the processor 210 constructs the virtual space 11 by using the panorama image 13. More specifically, the processor 210 develops a partial image of the panorama image 13 on each mesh forming the virtual space 11.

In Step S1820, the processor 210 arranges various objects including the virtual camera 14 and operation object in the virtual space 11. At this time, the processor 210 arranges the virtual camera 14 in a work area of the memory at a center 12 defined in advance in the virtual space 11.

In Step S1830, the processor 210 serves as the field-of-view image generation module 1429 to generate field-of-view image data for displaying the initial field-of-view image 17 (portion of the panorama image 13). The generated field-of-view image data is transmitted to the HMD 120 by the communication control module 540.

In Step S1832, the monitor 130 of the HMD 120 displays the field-of-view image 17 based on the signal received from the computer 200. As a result, the user 5 wearing the HMD 120 recognizes the virtual space 11.

In Step S1834, the HMD sensor 410 detects the position and inclination (motion of user 5) of the HMD 120 based on a plurality of infrared rays output by the HMD 120. The detection result is transmitted to the computer 200 as motion detection data.

In Step S1840, the processor 210 serves as the virtual camera control module 1421 to change the position and inclination of the virtual camera 14 based on the motion detection data input from the HMD sensor 410. As a result, the position and inclination (reference line of sight 16) of the virtual camera 14 are updated in association with the motion of the head of the user 5. The field-of-view region determination module 1422 defines the field-of-view region 15 in accordance with the position and inclination of the virtual camera 14 after the change.

In Step S1846, the third camera 165 detects the depth information on the hand of the user 5, and transmits the detected depth information to the computer 200.

In Step S1850, the processor 210 serves as the tracking module 1425 to detect the position of the hand of the user 5 in the uvw visual-field coordinate system based on the received depth information. The processor 210 then serves as the operation object control module 1428 to move the operation object in association with the detected position of the hand of the user 5. At this time, when the processor 210 has received a user operation on another object because, for example, the operation object has touched another object, the processor 210 executes processing determined in advance for the operation.

In Step S1860, the processor 210 serves as the field-of-view image generation module 1429 to generate field-of-view image data for displaying the field-of-view image 17 photographed by the virtual camera 14, and outputs the generated field-of-view image data to the HMD 120.

In Step S1862, the monitor 130 of the HMD 120 displays the updated field-of-view image based on the received field-of-view image data. As a result, the field of view of the user in the virtual space 11 is updated.

[User Operation]

Next, an operation in the virtual space 11 based on the line of sight of the user 5 and the motion of the hand of the user 5 are described with reference to FIG. 19 to FIG. 21.

FIG. 19 is a field-of-view image 1917 of the user according to at least one embodiment of this disclosure. FIG. 20 is a diagram of the virtual space 11 corresponding to the field-of-view image 1917 in FIG. 19 according to at least one embodiment of this disclosure.

The field-of-view image 1917 in FIG. 19 corresponds to the field-of-view region 15, which is the photography range of the virtual camera 14 in FIG. 20. The field-of-view image 1917 includes a left hand object 1941, a right hand object 1942, a cylinder object 1943, and a box object 1944.

Referring to FIG. 20, a line of sight 2046 represents the line of sight of the user 5 in the virtual space 11 detected by the line-of-sight detection module 1424. In FIG. 20, the line of sight 2046 of the user 5 and the box object 1944 intersect. In other words, the line of sight 2046 may also be said to be colliding with the box object 1944.

A pointer object 1945 is arranged at a collision point at which the line of sight 2046 collides with the box object 1944. The control module 510 treats the object (box object 1944) with which the line of sight 2046 collides as being in a state designated by the user 5.

In at least one aspect, the control module 510 may change the display mode (e.g., color and pattern) of the box object 1944 before and after the collision with the line of sight 2046. In this way, the user 5 is able to easily recognize whether the box object 1944 is designated by the user 5.

The control module 510 receives an operation by the user 5 on the designated object based on the motion of at least a part of the limbs of the user 5. In the following, as an example, the control module 510 receives an operation on the designated box object 1944 based on the shape of the hand of the user 5.

In FIG. 19 and FIG. 20, the right hand object 1942 is opened. In other words, the right hand of the user 5 is also opened in the real space. The palm of the right hand object 1942 is facing the box object 1944.

In at least one aspect, when the tracking module 1425 recognizes based on the tracking data that the hand of the user 5 is opened, the tracking module 1425 detects the normal to the palm of the user 5 in the real space. The control module 510 detects, based on the normal detected by the tracking module 1425, a normal 2047 to the palm of the right hand object 1942 arranged in the virtual space 11. In FIG. 20, the line of sight 2046 and the normal 2047 are substantially facing the same direction.

FIG. 21 is a diagram of a field-of-view image 2117 after the right hand object 1942 has transitioned from an opened state in FIG. 19 to a closed state according to at least one embodiment of this disclosure.

The tracking module 1425 detects, based on the tracking data, that the right hand of the user 5 has transitioned from an opened state to a closed state. The control module 510 receives an operation on the designated box object 1944 in accordance with the transition from a state in which the right hand of the user 5 is opened to a state in which the right hand is closed under a state in which the line of sight 2046 and the normal 2047 are substantially in the same direction.

In FIG. 21, the control module 510 moves the box object 1944 toward the right hand object 1942. As a result of this, the user 5 is able to perform an operation on an object that he or she wishes to operate in the virtual space 11 based on the line of sight and a hand motion even without the user 5 approaching the object.

(Control Structure)

FIG. 22 is a flowchart of processing of receiving a user operation based on the line of sight of the user 5 and a motion of a part of his or her limbs according to at least one embodiment of this disclosure. The processing in FIG. 22 is implemented by the processor 210 reading and executing a control program stored in the storage 230.

In Step S2205, the processor 210 defines the virtual space 11. In Step S2210, the processor 210 serves as the virtual object generation module 1427 to arrange two types of objects. Specifically, the virtual object generation module 1427 arranges an object capable of receiving an operation by the user 5 and an object incapable of receiving a user operation. In the following description, the object capable of receiving an operation by the user 5 is also referred to as a “first type of object”, and the object capable of receiving an operation by the user 5 is also referred to as a “second type of object”.

In at least one aspect, the first type of object is configured to collide with the line of sight 2046 and the second type object is configured not to collide with the line of sight 2046. In other words, the pointer object 1945 is arranged on the surface of the first type of object, but is not arranged on the surface of the second type of object. The user 5 is able to recognize based on the pointer object 1945 whether the object at which the line of sight 2046 is directed is capable of being operated. Examples of the second type of object include the virtual camera 14, the left hand object 1941, the right hand object 1942, and the avatar object. The avatar object corresponds to the user 5 or a user of the other computer 200.

As is described later with reference to FIG. 26, the object information 1432 stores data for rendering each object and information for defining whether the object collides with the line of sight 2046 in association with each other.

In Step S2220, the processor 210 serves as the line-of-sight detection module 1424 to detect the line of sight 2046 of the user 5 in the virtual space 11.

In Step S2225, the processor 210 identifies a first type of object (designated by line of sight 2046) arranged in the virtual space 11 and colliding with the detected line of sight 2046.

In Step S2230, the processor 210 serves as the tracking module 1425 to detect the tracking data representing the motion of the hand of the user 5.

In Step S2235, the processor 210 determines, based on the tracking data, whether the hand of the user 5 is opened. When the processor 210 determines that the hand of the user 5 is opened (YES in Step S2235), the processing advances to Step S2240. Otherwise, when the processor 210 determines that the hand of the user 5 is closed (NO in Step S2235), the processing returns to Step S2220.

In Step S2240, the processor 210 detects the normal 2047 to the palm of the hand object arranged in the virtual space 11.

In Step S2245, the processor 210 again detects the line of sight 2046, and determines whether the detected line of sight 2046 has deviated from the first type of object (designated object) identified in Step S2225. When the processor 210 determines that the line of sight 2046 has deviated from the identified first type of object (YES in Step S2245), the processing returns to Step S2220. Otherwise (NO in Step S2245), the processing advances to Step S2250.

In Step S2250, the processor 210 determines whether the line of sight 2046 and the normal 2047 are substantially in the same direction. As an example, the processor 210 determines that the line of sight 2046 and the normal 2047 are substantially in the same direction when the angle formed by the vector of line of sight 2046 and the vector of the normal 2047 is less than 10 degrees. When the processor 210 determines that the line of sight 2046 and the normal 2047 are substantially in the same direction (YES in Step S2250), the processing advances to Step S2260. Otherwise (NO in Step S2250), the processor 210 returns the processing to Step S2245.

In Step S2255, the processor 210 again detects the tracking data, and determines whether the hand of the user 5, which was determined to be opened in Step S2235, is closed. When the processor 210 determines that the hand of the user 5 is closed (YES in Step S2255), the processing advances to Step S2260. Otherwise (NO in Step S2255), the processor 210 returns the processing to Step S2245.

In Step S2260, the processor 210 serves as the control module 510 to move the identified first type of object in the direction of the hand object corresponding to normal 2047. After that, the processor 210 returns the processing to Step S2220.

In at least one aspect, the processor 210 may be configured to execute the processing of Step S2260 when, in Step S2255, the hand object is detected as having moved in a direction away from the identified first type of object.

In the above-mentioned example, the control module 510 is configured to move the designated object toward the viewpoint of the user 5 in the virtual space 11, but the movement direction of the object is not limited to that. For example, the control module 510 may detect that the user 5 has performed a motion (punching) of pushing out an arm in the direction of the designated object or a motion (kicking) of raising a leg in the direction of the designated object. The control module 510 may also move the object in a direction opposite to the viewpoint of the user 5 in the virtual space 11 in accordance with the detection result.

(Tactile Feedback)

In the above example, the user 5 inputs to the computer 200 an operation on the object by moving his or her hand in the space 1500. At this time, the user 5 recognizes by visual or auditory perception that the operation has been input to the computer 200. For example, the computer 200 outputs a notification sound from the speaker 180 in accordance with the input of the operation. Next, processing of providing tactile feedback on the operation to the user 5 is described with reference to FIG. 23.

FIG. 23 is a diagram of tactile feedback processing according to at least one embodiment of this disclosure. A field-of-view image 2317 in FIG. 23 includes a UI 2151. The UI 2151 includes a tutorial button 2152, a setting button 2153, a back button 2154, and an end button 2155. In at least one aspect, the user 5 changes a setting in the virtual space 11 by operating the UI 2151.

The user 5 operates the UI 2151 based on the line of sight 2046 and the motion of both hands. As at least one example, there is described a case in which the user 5 operates the setting button 2153.

The user 5 directs his or her line of sight 2046 at the setting button 2153. As a result, the pointer object 1945 is displayed on the setting button 2153 in the field-of-view image 2317.

The user 5 brings one hand into contact with his or her other hand under a state in which the line of sight 2046 is directed at the setting button 2153. In FIG. 23, the user 5 is touching the back of the left hand with the index finger of the right hand. Therefore, in the virtual space 11, the index of the right hand object 1942 is touching the back of the left hand object 1941.

The control module 510 receives the operation of the user 5 on the designated object (setting button 2153) in accordance with the contact between the left hand object 1941 and the right hand object 1942.

With this configuration, even when the user 5 does not approach the setting button 2153 in the virtual space 11, the user 5 is able to input an operation on the button to the computer 200. The contact between the left hand object 1941 and the right hand object 1942 is a trigger for the operation. More specifically, the contact between the left hand and the right hand of the user 5 in the real space triggers the operation. As a result, the user 5 is able to recognize that the setting button 2153 has been properly operated by obtaining tactile feedback on the operation.

In other approaches, when the user 5 tries to operate the setting button 2153 with the left hand object 1941 or the right hand object 1942, the user 5 to move his or her hand by a large amount in the real space. On the other hand, with the above-described control, the user 5 can input to the computer 200 an operation on the setting button 2153 by simply bringing both hands into contact with each other.

In at least the example described above, the operation on the designated object is triggered by bringing both hands of the user 5 into contact, but in at least one aspect, the operation may be bringing a first part (e.g., hand) of the body of the user 5 into contact with a second part of the body (e.g., foot or arm).

[Control for Reducing Processing Load]

In general, when providing the virtual space to the HMD 120, the computer 200 outputs a high-quality image to the monitor 130 at a high frame rate. The reason for this is to suppress a deterioration in the sense of immersion in the virtual space 11 caused by the user 5 recognizing an image having a low image quality.

However, the processing described above places a heavy load on the computer 200. As a result, depending on the performance of the computer 200, the image output to the monitor 130 may become jerky. In this case, too, the sense of immersion by the user 5 in the virtual space 11 deteriorates.

Therefore, in order to help solve this problem, the computer 200 according to at least one embodiment of this disclosure executes control for reducing the processing load while suppressing a reduction in the sense of immersion by the user 5 in the virtual space 11. The details of this control are now specifically described.

FIG. 24 is a diagram of an inner region IS and an outer region OS according to at least one embodiment of this disclosure. FIG. 25 is a diagram of a field-of-view image 2517 corresponding to the field-of-view region 15 of FIG. 24 according to at least one embodiment of this disclosure.

Referring to FIG. 24, box objects 2156 and 2157 and an avatar object 2158 are arranged in the field-of-view region 15, which is the photography range of the virtual camera 14. The avatar object 2158 corresponds to the user of another computer 200 (hereinafter also referred to as “another user”). The user 5 can communicate to and from the other user in the virtual space 11 via the avatar object 2158.

In FIG. 24 and FIG. 25, the line of sight 2046 of the user 5 and the box object 2156 intersect. Therefore, the pointer object 1945 is arranged on the box object 2156.

In at least aspect, the processor 210 sets a spherical inner region IS centered around the position of the pointer object 1945 (i.e., intersection at which line of sight 2046 intersects box object 2156). The region outside the inner region IS is defined as the outer region OS.

In the field-of-view image 17 output to the monitor 130, the processor 210 sets the image quality of the image corresponding to the outer region OS to be lower than the image quality of the image corresponding to the inner region IS. The resolution of the retina in the human eye differs depending on the location. Specifically, the resolution is highest in the center of the retina, and decreases as the distance from the center of the retina increases. Therefore, even when the image quality of the image corresponding to the outer region OS is reduced, the user 5 does not feel strange, and there is no deterioration in the sense of immersion by the user 5 in the virtual space 11. As a result, the computer 200 can reduce the image processing load while suppressing deterioration in the sense of immersion by the user 5 in the virtual space 11. The size of the inner region IS is set to a range in which the user 5 does not feel strange.

As at least one example, the processor 210 renders the objects included in the inner region IS at a high image quality and renders the objects included in the outer region OS at a low image quality. In FIG. 24 and FIG. 25, the box object 2156 is included in the inner region IS, and the box object 2157 and the avatar object 2158 are included in the outer region OS.

The processor 210 renders the box object 2156 included in the inner region IS at a high image quality. In at least one aspect, the processor 210 renders the box object 2156 using rendering data with a large number of polygons. In at least one aspect, the processor 210 renders the box object 2156 using rendering data having a high texture resolution.

A polygon is a plane figure (e.g., triangle) with three or more straight sides used when representing a curved surface of an object. When there is a larger number of polygons, the object is represented more smoothly. Texture is an image attached to the surface of an object in order to express how the object looks and feels (e.g., glossy). When the texture resolution is higher, the object has a higher level of detail.

In at least one aspect, the processor 210 renders the box object 2156 by using a shader having a high processing load. A shader is a program for performing shading processing on an object. In general, the shading of an object is expressed in more detail when the processing load of the shader is higher.

On the other hand, the processor 210 renders the box object 2157 and the avatar object 2158 included in the outer region OS at a low image quality. In at least one aspect, the processor 210 renders those objects by using rendering data having a low number of polygons. In at least one aspect, the processor 210 renders those objects by using rendering data having a low texture resolution. In at least one aspect, the processor 210 renders the shading of those objects by using a shader having a low processing load.

In the field-of-view image 2517 displayed on the monitor 130, the resolution of the image corresponding to the inner region IS and the resolution of the image corresponding to the outer region OS are the same resolution.

In at least one embodiment, the storage 230 stores the rendering data of each object arranged in the virtual space 11 for the case in which those objects are included in the inner region IS as well as for the case in which those objects are included in the outer region OS.

FIG. 26 is a diagram of a data structure of the object information 1432 according to at least one embodiment of this disclosure. Referring to FIG. 26, the object information 1432 stores rendering data for high image quality, rendering data for low image quality, and a collision determination in association with each object.

The rendering data for high image quality is used when the object is included in the inner region IS. On the other hand, the rendering data for low image quality is used when the object is included in the outer region OS. The collision determination indicates whether the object collides with the line of sight 2046. As described above, the first type of object collides with the line of sight 2046, and the second type of object does not collide with the line of sight 2046.

For a given object, the number of polygons of the rendering data for low image quality is smaller than the number of polygons of the rendering data for high image quality, and the texture resolution of the rendering data for low image quality is lower than the texture resolution of the rendering data for high image quality.

As an example of the data for rendering the box object 2156, the storage 230 stores rendering data for high quality having a “large” number of polygons and a “high” texture resolution and rendering data for low image quality having a “small” number of polygons and a “high” texture resolution.

(Control Structure)

FIG. 27 is a flowchart of a series of controls for reducing the image processing load on the computer 200 according to at least one embodiment of this disclosure. Each processing in FIG. 27 is implemented by the processor 210 reading and executing a control program stored in the storage 230, in at least one embodiment.

In Step S2710, the processor 210 serves as the virtual space definition module 1426 to define the virtual space 11.

In Step S2720, the processor 210 serves as the virtual object generation module 1427 to arrange the first type and the second type of objects in the virtual space 11 (defines region to be occupied by each object in virtual space 11). The second type of object includes the virtual camera 14.

In Step S2730, the processor 210 identifies the field-of-view region 15 based on the position and inclination (reference line of sight 16) of the virtual camera 14.

In Step S2740, the processor 210 serves as the line-of-sight detection module 1424 to detect the line of sight 2046 of the user 5 in the virtual space 11.

In Step S2750, the processor 210 detects the intersection (position of pointer object 1945) at which the detected line of sight 2046 and the first type of object intersect. The processor 210 also sets an inner region IS centered around the detected intersection and an outer region OS outside thereof.

In at least one aspect, the processor 210 may detect the intersection between the line of sight 2046 and the object that first intersects the line of sight 2046, irrespective of the type of object (first type or second type), and set the inner region IS and the outer region OS centered around the intersection. In this case, the region is set centered around the object at which the user is actually directing his or her line of sight 2046.

In Step S2760, the processor 210 serves as the control module 510 to render, of the objects arranged in the identified field-of-view region 15, the objects included in the outer region OS at a low image quality and the objects included in the inner region IS at a high image quality. As an example, the processor 210 refers to the object information 1432, and renders the objects included in the outer region OS using the rendering data for low image quality and the objects included in the inner region IS using the rendering data for high image quality.

In Step S2770, the processor 210 serves as the field-of-view image generation module 1429 to generate a field-of-view image 17 corresponding to the field-of-view region 15.

In Step S2780, the processor 210 outputs the generated field-of-view image 17 to the monitor 130. Then, the processor 210 again executes the processing of Step S2730.

With the processing described above, the computer 200 according to at least one embodiment of this disclosure can reduce the image processing load of the objects arranged in the outer region OS. As a result, even when the performance of the computer 200 is low, the computer 200 can suppress a deterioration in the sense of immersion by the user 5 in the virtual space 11.

In at least the example described above, the computer 200 sets two regions, namely, the inner region IS and the outer region OS, but in at least one aspect, three or more regions having different image qualities may be set.

[Control of Size of Pointer Object]

Next, processing for controlling the size of the pointer object 1945 is described with reference to FIG. 28.

FIG. 28 is a diagram of a field-of-view image 2817 including the pointer object 1945 according to at least one embodiment of this disclosure. FIG. 29 is a diagram of the virtual space 11 corresponding to the field-of-view image 2817 in FIG. 28 according to at least one embodiment of this disclosure.

The field-of-view image 2817 corresponds to the field-of-view region 15. In the field-of-view region 15, the cylinder object 1943, the box object 1944, and a tree object 2161 are arranged.

The tree object 2161 is arranged closer to the virtual camera 14 than the cylindrical object 1943 and the box object 1944.

When the size of the pointer object 1945 in the virtual space 11 is constant, the size of the pointer object 1945 in the field-of-view image 2817 is larger when the pointer object 1945 is closer to the virtual camera 14.

In the field-of-view image 2817, the pointer object 1945 arranged on the tree object 2161 is larger than the pointer object 1945 arranged on the box object 1944.

In the field-of-view image 2817, the pointer object 1945 is a hindrance to the user 5 when the pointer object 1945 is close to the virtual camera 14. On the other hand, the pointer object 1945 is difficult for the user 5 to visually recognize the pointer object 1945 when the pointer object 1945 is far from the virtual camera 14.

In order to help solve such a problem, the computer 200 according to at least one embodiment of this disclosure calculates a distance DIS between the pointer object 1945 and the virtual camera 14, and controls the size of the pointer object 1945 based on the distance DIS. As an example, the computer 200 reduces the size of the pointer object 1945 when the distance DIS is smaller. More specifically, the computer 200 controls the size of the pointer object 1945 in the virtual space 11 such that the size of the pointer object 1945 is always constant in the field-of-view image visually recognized by the user 5.

(Control Structure)

FIG. 30 is a flowchart of processing of controlling the size of the pointer object 1945 in the virtual space 11 according to at least one embodiment of this disclosure. Each processing in FIG. 30 is implemented by the processor 210 reading and executing a control program stored in the storage 230, in at least one embodiment. Of the processing in FIG. 30, processing that is the same as that described above is denoted with like reference numerals, and a description thereof is omitted here.

In Step S3005, the processor 210 detects an intersection at which the detected line of sight 2046 and the first type of object intersect.

In Step S3010, the processor 210 calculates the distance DIS between the viewpoint of the user 5 in the virtual space 11 (i.e., position of virtual camera 14) and the detected intersection.

In Step S3020, the processor 210 sets a value (pixel number) obtained by multiplying the calculated distance DIS by a value determined in advance (e.g., tan 5 degrees) as the size of the pointer object 1945.

In Step S3030, the processor 210 arranges at the intersection the pointer object 1945 having the set size.

In Step S3040, the processor 210 serves as the field-of-view image generation module 1429 to generate a field-of-view image, and outputs the generate field-of-view image to the monitor 130. Then, the processor 210 again executes the processing of Step S2220.

With the processing described above, the size of the pointer object 1945 in the field-of-view image visually recognized by the user 5 is always constant regardless of the distance DIS. As a result, the computer 200 according to at least one embodiment of this disclosure is capable of suppressing a deterioration in the sense of immersion by the user 5 in the virtual space 11 due to a change in the size of the pointer object 1945.

### CONFIGURATIONS

The technical features disclosed above are summarized in the following manner.

### Configuration 1

According to at least one embodiment of this disclosure, there is provided a program to be executed by a computer 200 to provide a virtual space 11 to an HMD 120. This program causes the computer 200 to execute defining the virtual space 11 (Step S2205). The computer further executes arranging one or more objects capable of receiving an operation by a user 5 of the HMD 120 in the virtual space 11 (Step S2210). The computer further executes detecting a line of sight 2046 of the user 5 (Step S2220). The computer further executes identifying, from among the one or more objects, an object designated by the detected line of sight 2046 (Step S2225). The computer further executes detecting a motion of at least a part of limbs of the user 5 (Step S2230). The computer further executes receiving an operation on the identified object based on the detection result of the motion of at least a part of the limbs of the user 5 (Step S2260).

### Configuration 2

In Configuration 1, the at least a part of the limbs of the user 5 includes a hand of the user 5, and the receiving of the operation includes receiving an operation in accordance with a shape of the hand of the user 5 (Step S2235 and Step S2255).

### Configuration 3

In Configuration 2, the detecting of the motion includes detecting, when the hand of the user 5 is opened (YES in Step S2235), a normal to a palm of the hand (Step S2240), and the receiving of an operation in accordance with a shape of the hand of the user 5 includes receiving an operation in accordance with a change from a state in which the normal and the line of sight 2046 are substantially the same direction (YES in Step S2250) to a state in which the hand of the user 5 is closed (YES in Step S2255).

### Configuration 4

In Configuration 1, the detecting of the motion includes detecting a motion of a first part of the limbs of the user 5 and detecting a motion of a second part of the limbs of the user 5, and the receiving of the operation includes receiving an operation based on contact between the first portion and the second portion (FIG. 23).

### Configuration 5

The program according to any one of Configurations 1 to 4, where the computer is further configured to execute arranging a pointer object 1945 at an intersection at which the detected line of sight 2046 and the object intersect (Step S3030). The computer further executes calculating a distance DIS between a viewpoint of the user 5 and the intersection in the virtual space 11 (Step S3010); and reducing a size of the pointer object 1945 when the calculated distance DIS is smaller.

### Configuration 6

In Configuration 5, the reducing of the size of the pointer object 1945 includes setting the size of the pointer object 1945 based on a value obtained by multiplying the calculated distance DIS by a value determined in advance (Step S3020).

### Configuration 7

The program according to any one of Configurations 1 to 6, wherein the computer is further configured to execute displaying on the HMD 120 a field-of-view image having an inner region IS including an intersection at which the detected line of sight 2046 and the object intersect and an outer region OS outside the inner region IS, the outer region OS having a lower image quality than the inner region IS (Step S2760 to Step S2780).

### Configuration 8

The program according to Configuration 7, wherein the computer is further configured to execute detecting a motion of the HMD 120 (Step S1834). The computer further executes updating the field-of-view image in association with the detected motion (Step S1840 and Step S1860). The updating of the field-of-view image includes setting the image quality of an object positioned in the outer region OS to be lower than the image quality of that object positioned in the inner region IS (Step S2760).

### Configuration 9

In Configuration 8, the setting of the image quality of an object to be lower includes setting a number of polygons of an object positioned in the outer region to be lower than a number of polygons of that object positioned in the inner region IS.

### Configuration 10

In Configuration 8 or 9, the setting of the image quality of an object to be lower includes setting a texture resolution of an object positioned in the outer region OS to be lower than a texture resolution of that object positioned in the inner region IS.

### Configuration 11

In any one of Configurations 8 to 10, object information 1432 stored in a storage 230 stores, for each of one or more objects, a plurality of pieces of rendering data of different image qualities for forming an object. The setting of the image quality of an object to be lower includes rendering the object by using, of the plurality of pieces of rendering data, rendering data for high image quality when the object is positioned in the inner region IS and rendering data for low image quality, which has a lower image quality than the rendering data for high image quality, when the object is positioned in the outer region OS (Step S2760).

One of ordinary skill in the art would understand that the embodiments disclosed herein are merely examples in all aspects and in no way intended to limit this disclosure. The scope of this disclosure is defined by the appended claims and not by the above description, and this disclosure encompasses all modifications made within the scope and spirit equivalent to those of the appended claims.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

1-6. (canceled)

7. A method of providing a virtual space, the method comprising:
defining a virtual space, wherein the virtual space comprises an operation object and a target object,
detecting a line of sight of a user wearing a head-mounted device (HMD);
identifying whether the detected line of sight intersects with the target object;
detecting a motion of a part of a body of the user;
moving the operation object in accordance with the detected motion; and
performing an operation on the identified target object in accordance with the detected motion in response to the detected line of sight intersecting with the target object.

8. The method according to claim 7,
wherein the part of the body of the user comprises a hand of the user, and the operation object corresponds to the hand of the user.

9. The method according to claim 8, further comprising identifying a direction normal to a palm of the operation object in response to a determination that the hand of the user is in an open state.

10. The method according to claim 9, wherein the performing of the operation on the target object in response to detecting the hand of the user transitioning to a closed state from a state in which the direction of the normal and the line of sight are facing a same direction.

11. The method according to claim 9, wherein the performing of the operation on the target object in response to detecting the hand of the user transitioning to a closed state from a state in which the direction of the normal and the line of sight both intersect the target object.

12. The method according to claim 7,
wherein the target object comprises a menu including a portion in which a plurality of options is displayed, and the part of the body of the user comprises a first part and a second part.

13. The method according to claim 12, further comprising selecting an option of the plurality of options in response to the line of sight intersecting the option and detecting contact between the first part and the second part.

14. The method according to claim 7, further comprising arranging a virtual pointer object at an intersection between the line of sight extending from a virtual viewpoint and the target object.

15. The method according to claim 14, further comprising:
identifying a distance between the virtual viewpoint and the intersection; and
changing a size of the virtual pointer object based on the identified distance.

16. The method according to claim 7, further comprising:
defining a visual field in the virtual space in accordance with a detected motion of the HMD;
generating a visual-field image in accordance with the visual field;
displaying the visual-field image on the HMD;
identifying a first range including the target object and a second range outside the first range in response to the line of sight intersecting the target object; and
setting an image quality of a range corresponding to the second range in the visual-field image to be different from an image quality of a range corresponding to the first range in the visual-field image.

17. The method according to claim 16, further comprising returning, in response to performing the operation on the identified target object, the image quality of the range corresponding to the second range to be equal to the image quality of the range corresponding to the first range.

18. A method of providing a virtual space, the method comprising:
defining a virtual space, wherein the virtual space comprises an operation object, a target object, a virtual viewpoint and a virtual pointer object,
detecting a line of sight of a user wearing a head-mounted device (HMD);
positioning the virtual pointer object on the target object in response to the line of sight intersecting with the target object;
defining a first range surrounding the target object in response to the positioning of the virtual pointer object on the target object; and
reducing an image quality of the virtual space outside of the first range.

19. The method according to claim 18, further comprising:
detecting a motion of a part of a body of the user other than a head of the user;
moving the operation object in accordance with the detected motion; and
operating the target object in the virtual space in accordance with the detected motion in response to the positioning of the virtual pointer object on the target object.

20. The method according to claim 18, wherein the part of the body of the user comprises a first part and a second part, the target object comprises a menu comprising a plurality of options, and the operating the target object comprises selecting an option of the plurality of options in response to detecting the first part contacting the second part.

21. The method according to claim 20, wherein the first part is a left hand of the user and the second part is a right hand of the user.

22. A system comprising:
a non-transitory computer readable medium configured to store instructions thereon; and
a processor connected to the non-transitory computer readable medium, wherein the processor is configured to execute the instructions for:
defining a virtual space, wherein the virtual space comprises an operation object and a target object,
detecting a line of sight of a user;
identifying whether the detected line of sight intersects with the target object;
detecting a motion of a part of a body of the user;
moving the operation object in accordance with the detected motion; and
performing an operation on the identified target object in accordance with the detected motion in response to the detected line of sight intersecting with the target object.

23. The system according to claim 22, wherein the processor is further configured to execute the instructions for defining a menu as the target object, and the menu comprises a plurality of displayed options.

24. The system according to claim 23, wherein the processor is further configured to execute the instructions for selecting a displayed option of the plurality of displayed options in response to the line of sight intersecting the displayed option and detecting contact between a first part of a body of the user and a second part of the body of the user.

25. The system according to claim 22, wherein the processor is further configured to execute the instructions for:
arranging a virtual pointer object at an intersection between the line of sight extending from a virtual viewpoint and the target object;
identifying a distance between the virtual viewpoint and the intersection; and
changing a size of the virtual pointer object based on the identified distance.

26. The system according to claim 22, wherein the processor is further configured to execute the instructions for:
identifying a first range including the target object and a second range outside the first range in response to the line of sight intersecting the target object; and
setting an image quality of a range corresponding to the second range in the virtual space to be different from an image quality of a range corresponding to the first range in the virtual space.
